(19) United States
(12) Patent Application Publication
(10) Pub. No.: US 2025/0309505 A1
(43) Pub. Date: Oct. 2, 2025

(54) ALL-SOLID-STATE BATTERY

(71) Applicant: HONDA MOTOR CO., LTD., Tokyo (JP)

(72) Inventor: Akihiro TAGUCHI, Saitama (JP)

(21) Appl. No.: 19/058,032

(22) Filed: Feb. 20, 2025

(30) Foreign Application Priority Data
Mar. 30, 2024 (JP) 2024-058345

(51) Int. Cl. H01M 50/586; H01M 4/75; H01M 50/595

(52) U.S. Cl. CPC H01M 50/586; H01M 4/75; H01M 50/595

(57) ABSTRACT

An all-solid-state battery according to one embodiment of the present invention includes an electrode laminate comprising, in the following order, a positive electrode charge-collecting foil, a positive electrode layer, a solid-state electrolyte layer, a negative electrode layer, and a negative electrode charge-collecting foil. An edge of the positive electrode layer is located inward of edges of the solid-state electrolyte layer and the negative electrode layer. The positive electrode charge-collecting foil has a positive electrode charge-collecting foil extension that is coupled to a positive electrode tab. The negative electrode charge-collecting foil has a negative electrode charge-collecting foil extension that is coupled to a negative electrode tab. An insulating frame is disposed at an outer edge of the positive electrode layer.

This application is based on and claims the benefit of priority from Japanese Patent Application No. 2024-058345, filed on 30 Mar. 2024, the content of which is incorporated herein by reference.

### BACKGROUND OF THE INVENTION

### Field of the Invention

The present invention relates to an all-solid-state battery.

### Related Art

In recent years, research and development has been conducted on secondary batteries that contribute to energy efficiency in order to ensure that more people have access to affordable, reliable, sustainable, and advanced energy. Among secondary batteries, all-solid-state batteries with a laminated structure including, in the following order, a positive electrode charge-collecting foil, a positive electrode layer, a solid-state electrolyte layer, a negative electrode layer, and a negative electrode charge-collecting foil, in particular, have attracted attention because of their superiority in terms of improved safety and higher energy density due to the nonflammability of the solid-state electrolyte.

For all-solid-state batteries with this laminated structure, a configuration is known in which the positive electrode charge-collecting foil is coupled to the positive electrode tab at the extension of the positive electrode charge-collecting foil, and the negative electrode charge-collecting foil is connected to the negative electrode tab at the extension of the negative electrode charge-collecting foil. For all-solid-state batteries with such a configuration, in order to prevent damage to the extension of the positive or negative electrode charge-collecting foil due to concentration of external load or stress, disposing a ceramic layer or buffer material on the surface of the extension of the charge-collecting foil has been studied (see Patent Documents 1 and 2).
Patent Document 1: Japanese Unexamined Patent Application, Publication No. 2022-104116
Patent Document 2: Japanese Unexamined Patent Application, Publication No. 2023-39756

### SUMMARY OF THE INVENTION

By the way, for secondary batteries, the challenges are to achieve high capacity and to suppress short-circuits between the positive and negative electrodes. As a high-capacity all-solid-state battery, an all-solid-state lithium battery has been studied in which lithium ions are used as the charge-transfer medium, lithium in the positive electrode layer is deposited on the negative electrode layer during charging, and lithium in the negative electrode layer is absorbed in the positive electrode layer during discharging. In all-solid-state lithium batteries, the thickness of the negative electrode layer changes with charging and discharging. For this reason, in all-solid-state lithium batteries, the positive electrode charge-collecting foil extension and the negative electrode charge-collecting foil extension are preferably deformable with changes in the thickness of the negative electrode layer. However, deformation of the negative electrode charge-collecting foil extension with changes in the thickness of the negative electrode layer can cause a short-circuit between the negative electrode charge-collecting foil extension and the positive electrode charge-collecting foil. Besides, if the negative electrode charge-collecting foil extension and positive electrode charge-collecting foil are disposed close to each other immediately after manufacturing due to manufacturing variations, external vibration may cause a short-circuit between the negative electrode charge-collecting foil extension and the positive electrode charge-collecting foil.

An object of the present invention, which has been made in view of these circumstances, is to provide an all-solid-state battery in which a short-circuit is less likely to occur between the negative electrode charge-collecting foil extension at which the negative electrode charge-collecting foil and the negative electrode tab are coupled to each other, and the positive electrode charge-collecting foil.

Regarding an all-solid-state battery with an electrode laminate including, in the following order, a positive electrode charge-collecting foil, a positive electrode layer, a solid-state electrolyte layer, a negative electrode layer, and a negative electrode charge-collecting foil, in which the positive electrode charge-collecting foil has a positive electrode charge-collecting foil extension coupled to a positive electrode tab and the negative electrode charge-collecting foil has a negative electrode charge-collecting foil extension coupled to a negative electrode tab, the inventors have completed the present invention, having found that the aforementioned problem can be solved by disposing an insulating frame on the outer edge of the positive electrode layer and attaching a flexible insulating tape to the surface of the negative electrode charge-collecting foil extension on the positive electrode layer side so that the edge of the solid-state electrolyte layer on the negative electrode charge-collecting foil extension side faces the insulating tape, being at a distance from the negative electrode layer. Therefore, the present invention provides the following aspects.

A first aspect of the present invention relates to an all-solid-state battery including an electrode laminate including, in the following order, a positive electrode charge-collecting foil, a positive electrode layer, a solid-state electrolyte layer, a negative electrode layer, and a negative electrode charge-collecting foil, in which an edge of the positive electrode layer is located inward of edges of the solid-state electrolyte layer and the negative electrode layer, the positive electrode charge-collecting foil has a positive electrode charge-collecting foil extension that is coupled to a positive electrode tab, the negative electrode charge-collecting foil has a negative electrode charge-collecting foil extension that is coupled to a negative electrode tab, an insulating frame is disposed at an outer edge of the positive electrode layer, a flexible insulating tape is attached to a surface of the negative electrode charge-collecting foil extension on the positive electrode layer side, being at a distance from the negative electrode layer, and an edge of the solid-state electrolyte layer on the negative electrode charge-collecting foil extension side faces the insulating tape.

According to the all-solid-state battery of the first aspect, a flexible insulating tape is attached to the negative electrode charge-collecting foil extension, which makes a short-circuit less likely to occur between the negative electrode charge-collecting foil extension and the positive electrode charge-collecting foil. The insulating tape is flexible and can follow the deformation of the negative electrode charge-collecting foil extension. Accordingly, the negative electrode charge-collecting foil extension easily deforms with changes in the thickness of the negative electrode layer due to charging and discharging, and the insulating tape does not easily peel off even if the negative electrode charge-collecting foil extension is deformed. The flexible insulating tape is attached to the negative electrode charge-collecting foil extension, being at a distance from the negative electrode layer, which prevents the insulating tape from riding up on the negative electrode layer when it is attached to the negative electrode charge-collecting foil extension. Moreover, since the edge of the solid-state electrolyte layer on the negative electrode charge-collecting foil extension side faces the insulating tape, even if there is a gap between the insulating tape and the negative electrode layer, a short-circuit between the negative electrode charge-collecting foil extension and the positive electrode charge-collecting foil is unlikely to occur even if the negative electrode charge-collecting foil extension is deformed toward the positive electrode layer. Further, the insulating frame is disposed at the outer edge of the positive electrode layer, which makes a short-circuit less likely to occur between the positive electrode charge-collecting foil extension and the negative electrode charge-collecting foil even if the positive electrode charge-collecting foil extension is deformed.

A second aspect of the present invention relates to the all-solid-state battery as described in the first aspect, in which the solid-state electrolyte layer has a plurality of layers being two or more layers, and at least one of the plurality of layers of the solid-state electrolyte layer has an edge on the negative electrode charge-collecting foil extension side that is approximately flush with an edge of the insulating frame.

According to the all-solid-state battery of the second aspect, at least one of the solid-state electrolyte layers is supported by the insulating frame, which improves the strength of the solid-state electrolyte layer.

A third aspect of the present invention relates to the all-solid-state battery as described in the first or second aspect, in which the insulating tape has an extension that extends out from a position of an outer edge of the insulating frame, and a length of the extension is greater than or equal to a total thickness of the solid-state electrolyte layer, the positive electrode layer, and the positive electrode charge-collecting foil.

According to the all-solid-state battery of the third aspect, the length of the extension of the insulating tape is within the aforementioned range, which makes a short-circuit less likely to occur between the negative electrode charge-collecting foil extension and the positive electrode charge-collecting foil when the negative electrode charge-collecting foil extension is bent toward the positive electrode layer.

A fourth aspect of the present invention relates to the all-solid-state battery as described in any one of the first to fourth aspects, in which a thickness of the insulating tape is less than a distance between the negative electrode charge-collecting foil extension and the solid-state electrolyte layer.

According to the all-solid-state battery of the fourth aspect, the insulating tape and the solid-state electrolyte layer face each other with a gap therebetween, so that the insulating tape is less likely to be pushed by the solid-state electrolyte layer and the insulating tape is less likely to peel off from the negative electrode charge-collecting foil extension.

A fifth aspect of the present invention relates to the all-solid-state battery as described in the first aspect, in which the edge of the solid-state electrolyte layer on the negative electrode charge-collecting foil extension side is located near an edge of the insulating frame.

According to the all-solid-state battery of the fifth aspect, the edge of the solid-state electrolyte layer is located near the edge of the insulating frame, so that even if the negative electrode charge-collecting foil extension is deformed toward the positive electrode layer, a short-circuit is less likely to occur between the negative electrode charge-collecting foil extension and the positive electrode charge-collecting foil.

A sixth aspect of the present invention relates to the all-solid-state battery as described in the second aspect, in which the solid-state electrolyte layer has separate layers, the separate layers being: a positive electrode-side solid-state electrolyte layer located on the positive electrode layer side, a negative electrode-side solid-state electrolyte layer located on the negative electrode layer side, and a central solid-state electrolyte layer located between the positive electrode-side solid-state electrolyte layer and the negative electrode-side solid-state electrolyte layer, an edge of the positive electrode-side solid-state electrolyte layer on the negative electrode charge-collecting foil extension side is approximately flush with the edge of the insulating frame, an edge of the central solid-state electrolyte layer on the negative electrode charge-collecting foil extension side is located inward of the edge of the positive electrode-side solid-state electrolyte layer, and an edge of the negative electrode-side solid-state electrolyte layer on the negative electrode charge-collecting foil extension side is located inward of the edge of the central solid-state electrolyte layer.

A seventh aspect of the present invention relates to an all-solid-state battery including an electrode laminate including, in the following order, a positive electrode charge-collecting foil, a positive electrode layer, a solid-state electrolyte layer, a negative electrode layer, and a negative electrode charge-collecting foil, in which the positive electrode charge-collecting foil has a positive electrode charge-collecting foil extension that is coupled to a positive electrode tab, the negative electrode charge-collecting foil has a negative electrode charge-collecting foil extension that is coupled to a negative electrode tab, an insulating frame is disposed at an outer edge of the positive electrode layer, a flexible insulating tape is attached to a surface of the negative electrode charge-collecting foil extension on the positive electrode layer side, being at a distance from the negative electrode layer, an edge of the positive electrode layer on the negative electrode charge-collecting foil extension side is located inward of edges of the solid-state electrolyte layer and the negative electrode layer, an edge of the solid-state electrolyte layer on the negative electrode charge-collecting foil extension side faces the insulating tape, and a thickness of the insulating tape is less than a distance between the negative electrode charge-collecting foil extension and the solid-state electrolyte layer.

According to the all-solid-state battery of the seventh aspect, a flexible insulating tape is attached to the negative electrode charge-collecting foil extension, which makes a short-circuit less likely to occur between the negative electrode charge-collecting foil extension and the positive electrode charge-collecting foil. The insulating tape is flexible and can follow the deformation of the negative electrode charge-collecting foil extension. Accordingly, the negative electrode charge-collecting foil extension easily deforms with changes in the thickness of the negative electrode layer due to charging and discharging, and the insulating tape does not easily peel off even if the negative electrode charge-collecting foil extension is deformed. The flexible insulating tape is attached to the negative electrode charge-collecting foil extension, being at a distance from the negative electrode layer, which prevents the insulating tape from riding up on the negative electrode layer when it is attached to the negative electrode charge-collecting foil extension. Moreover, since the edge of the solid-state electrolyte layer on the negative electrode charge-collecting foil extension side faces the insulating tape, even if there is a gap between the insulating tape and the negative electrode layer, a short-circuit between the negative electrode charge-collecting foil extension and the positive electrode charge-collecting foil is less likely to occur even if the negative electrode charge-collecting foil extension is deformed toward the positive electrode layer. Further, the insulating tape is thin and the insulating tape is kept from contact with the solid-state electrolyte layer, which makes the solid-state electrolyte layer and the negative electrode layer less likely to peel off due to the insulating tape. Furthermore, the insulating frame is disposed at the outer edge of the positive electrode layer, which makes a short-circuit less likely to occur between the positive electrode charge-collecting foil extension and the negative electrode charge-collecting foil even if the positive electrode charge-collecting foil extension is deformed.

The present invention can provide an all-solid-state battery in which a short-circuit is less likely to occur between the negative electrode charge-collecting foil extension at which the negative electrode charge-collecting foil and the negative electrode tab are coupled to each other, and the positive electrode charge-collecting foil.

### BRIEF DESCRIPTION OF THE DRAWINGS

FIG. 1 is a plan view of an all-solid-state battery according to one embodiment of the present invention;

FIG. 2 is a cross-sectional view along the II-II line shown in FIG. 1;

FIG. 3 is a cross-sectional view along the III-III line shown in FIG. 1;

FIG. 4 is an enlarged view of the main part shown in FIG. 2; and

FIG. 5 is a plan view of the negative electrode charge-collecting foil shown in FIG. 4.

### DETAILED DESCRIPTION OF THE INVENTION

The following will describe an embodiment of the present invention with reference to the accompanying drawings. However, the following embodiment merely illustrates the present invention and the present invention is not limited to the following.

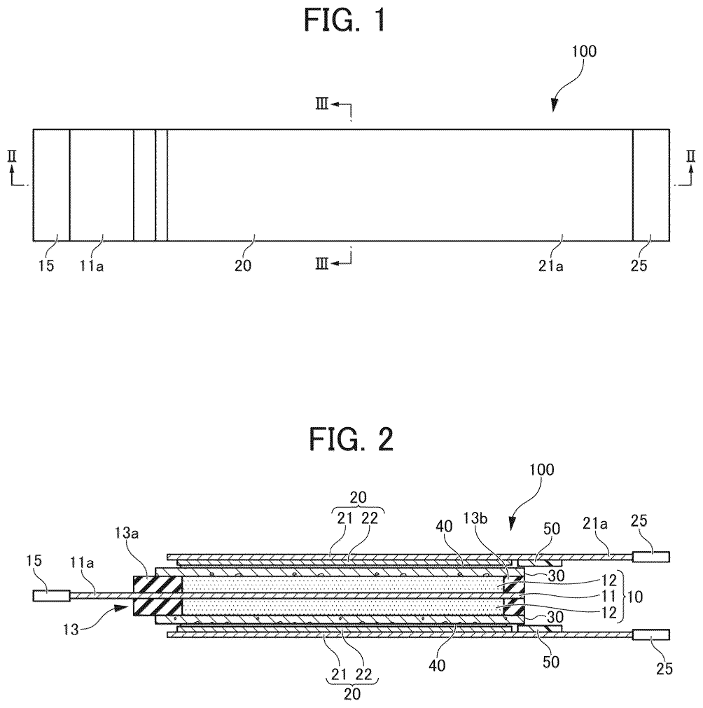

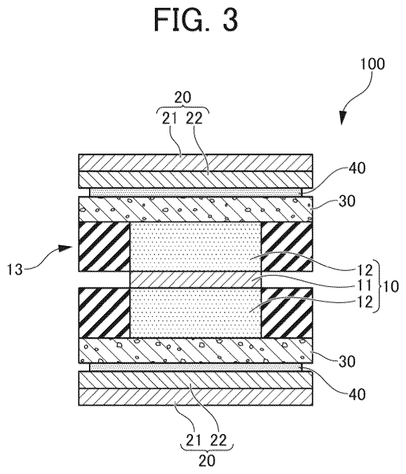

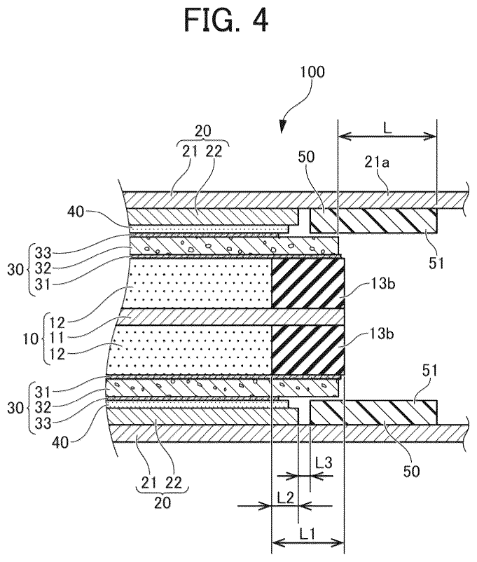

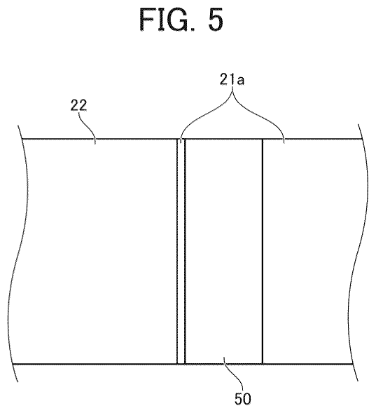

FIG. 1 is a plan view of an all-solid-state battery according to one embodiment of the present invention. FIG. 2 is a cross-sectional view along the II-II line shown in FIG. 1, FIG. 3 is a cross-sectional view along the III-III line shown in FIG. 1, FIG. 4 is an enlarged view of the main part shown in FIG. 2, and FIG. 5 is a plan view of the negative electrode charge-collecting foil shown in FIG. 4.

As shown in FIGS. 1 to 5, the all-solid-state battery 100 includes a positive electrode 10, a negative electrode 20, and a solid-state electrolyte layer 30 stacked between the positive electrode 10 and the negative electrode 20. The negative electrode 20 and the solid-state electrolyte layer 30 are laminated so that one positive electrode 10 is sandwiched between them. An intermediate layer 40 is disposed between the negative electrode 20 and the solid-state electrolyte layer 30. The positive electrode 10 includes a positive electrode charge-collecting foil 11 and a positive electrode layer 12 stacked on both surfaces of the positive electrode charge-collecting foil 11. The negative electrode 20 includes a negative electrode charge-collecting foil 21 and a negative electrode layer 22 stacked on the surface of the negative electrode charge-collecting foil 21 on the positive electrode 10 side. The all-solid-state battery 100 includes an electrode laminate including, in the following order, the positive electrode layer 12, the solid-state electrolyte layer 30, the negative electrode layer 22, and the negative electrode charge-collecting foil 21 on both surfaces of the positive electrode charge-collecting foil 11.

The positive electrode charge-collecting foil 11 has a positive electrode charge-collecting foil extension 11a that is coupled to the positive electrode tab 15. The positive electrode charge-collecting foil extension 11a does not have a positive electrode layer 12. The negative electrode charge-collecting foil 21 has a negative electrode charge-collecting foil extension 21a that is coupled to the negative electrode tab 25. The negative electrode charge-collecting foil extension 21a does not have the negative electrode layer 22 stacked thereon. The positive electrode charge-collecting foil extension 11a and the negative electrode charge-collecting foil extension 21a extend in opposite directions.

An insulating frame 13 is disposed at the outer edge of the positive electrode layer 12. An insulating frame 13a, which is located on the positive electrode charge-collecting foil extension 11a side, is wider than the insulating frame 13b on the negative electrode charge-collecting foil extension 21a side. The width of the insulating frame 13a on the positive electrode charge-collecting foil extension 11a side may be longer than the total thickness of the positive electrode layer 12, the solid-state electrolyte layer 30, the intermediate layer 40, and the negative electrode 20, for example. When the width of the insulating frame 13a is longer than that total thickness, a short-circuit is less likely to occur between the positive electrode charge-collecting foil extension 11a and the negative electrode charge-collecting foil 21 even if the positive electrode charge-collecting foil extension 11a is deformed. The width of the insulating frame 13a may be less than or equal to twice that total thickness. The width of the insulating frame 13b on the negative electrode charge-collecting foil extension 21a side (L1 in FIG. 4) is, for example, in the range of 2.0 mm or more and 4.0 mm or less.

A flexible insulating tape 50 is attached to the surface of the negative electrode charge-collecting foil extension 21a on the positive electrode 10 side, being at a distance from the negative electrode layer 22. The insulating tape 50 is a strip attached along the edge to the negative electrode layer 22 as shown in FIG. 5. The insulating tape 50 has an extension 51 located beyond the position of the outer edge of the insulating frame 13b. The length of the extension 51 (L in FIG. 4) may be greater than or equal to the total thickness of the solid-state electrolyte layer 30, the positive electrode layer 12, and the positive electrode charge-collecting foil 11. When the length of the extension 51 is greater than or equal to that total thickness, a short-circuit is less likely to occur between the negative electrode charge-collecting foil extension 21a and the positive electrode charge-collecting foil 11 when the negative electrode charge-collecting foil extension 21a is bent toward the positive electrode 10.

The solid-state electrolyte layer 30 has three separate layers, the separate layers being: a positive electrode-side solid-state electrolyte layer 31 located on the positive electrode layer 12 side, a negative electrode-side solid-state electrolyte layer 33 located on the negative electrode layer 22 side, and a central solid-state electrolyte layer 32 located between the positive electrode-side solid-state electrolyte layer 31 and negative electrode-side solid-state electrolyte layer 33. The positive electrode-side solid-state electrolyte layer 31 acts to improve adhesion between the positive electrode layer 12 and the central solid-state electrolyte layer 32. The negative electrode-side solid-state electrolyte layer 33 acts to improve adhesion between the negative electrode layer 22 and the central solid-state electrolyte layer 32. The positive electrode-side solid-state electrolyte layer 31 and the negative electrode-side solid-state electrolyte layer 33 are thinner than the central solid-state electrolyte layer 32. Regarding the positive electrode-side solid-state electrolyte layer 31 and the central solid-state electrolyte layer 32, the edge on the negative electrode charge-collecting foil extension 21a side is approximately flush with the edge of the insulating frame 13b. Being supported by the insulating frame 13b, the solid-state electrolyte layer 30 exhibits improved strength.

As shown in FIG. 4, the edge of each component on the negative electrode charge-collecting foil extension 21a side is located as follows. The edge of the positive electrode layer 12 is located inward of the edges of the solid-state electrolyte layer 30 and the negative electrode layer 22 (on the side opposite to the negative electrode tab 25 side). The edge of the positive electrode-side solid-state electrolyte layer 31 is approximately flush with the edge of the insulating frame 13b. The edge of the central solid-state electrolyte layer 32 is located inward of the edge of the positive electrode-side solid-state electrolyte layer 31. The edge of the negative electrode-side solid-state electrolyte layer 33 is located inward of the edge of the central solid-state electrolyte layer 32. The edge of the intermediate layer 40 is located between the edge of the negative electrode-side solid-state electrolyte layer 33 and the edge of the central solid-state electrolyte layer 32. The edge of the negative electrode layer 22 is located between the edge of the intermediate layer 40 and the edge of the central solid-state electrolyte layer 32. The relationship between the length of the negative electrode layer 22 from the edge of the positive electrode layer 12 to its own edge (in FIG. 4) and the width of the insulating frame 13b (in FIG. 4) may be any relationship and may be expressed by the ratio of the length of L2 to L1 that is in the range of 0.3 or more and 0.6 or less, for example. The distance between the negative electrode layer 22 and the insulating tape 50 (L3 in FIG. 4) is, for example, in the range of 0.5 mm or more and 1.0 mm or less. If the insulating tape 50 rides up on the negative electrode layer 22 due to variations caused by attaching the insulating tape 50 to the negative electrode charge-collecting foil extension 21a, the negative electrode layer 22 may be damaged and density variations may occur. For this reason, a gap is provided between the negative electrode layer 22 and the insulating tape 50 in this embodiment. However, with a gap between the negative electrode layer 22 and the insulating tape 50, a short-circuit may occur between the negative electrode charge-collecting foil extension 21a and the positive electrode charge-collecting foil 11 when the negative electrode charge-collecting foil extension 21a is bent toward the positive electrode 10. For this reason, the edge of the central solid-state electrolyte layer 32 is located to face the insulating tape 50. This makes a short-circuit less likely to occur between the negative electrode charge-collecting foil extension 21a and the positive electrode charge-collecting foil 11 even if the negative electrode charge-collecting foil extension 21a is bent toward the positive electrode 10.

The insulating tape 50 and the solid-state electrolyte layer 30 (central solid-state electrolyte layer 32) face each other with a gap therebetween.

In other words, the thickness of the insulating tape 50 is less than the distance between the negative electrode charge-collecting foil extension 21a and the central solid-state electrolyte layer 32 (the total thickness of the negative electrode layer 22, the intermediate layer 40, and the negative electrode-side solid-state electrolyte layer 33). Since the thickness of the insulating tape 50 is thin and the insulating tape 50 and the solid-state electrolyte layer 30 face each other with a gap therebetween, the solid-state electrolyte layer 30 is less likely to be pushed by the insulating tape 50 and the solid-state electrolyte layer 30 and the negative electrode layer 22 are less likely to peel off. The ratio of the thickness of the insulating tape 50 to the distance between the negative electrode charge-collecting foil extension 21a and the central solid-state electrolyte layer 32 is preferably in the range of 0.5 or more and 0.8 or less.

Examples of materials for the positive electrode charge-collecting foil 11, the positive electrode layer 12, the positive electrode tab 15, the negative electrode charge-collecting foil 21, the negative electrode layer 22, the negative electrode tab 25, the solid-state electrolyte layer 30, the intermediate layer 40, and the insulating tape will be described taking as an example the case where the all-solid-state battery 100 is an all-solid-state lithium battery in which lithium ions are used as the charge transfer medium.

The positive electrode charge-collecting foil 11 may be composed of any material and have any shape, as long as they provide the function of collecting charge for the positive electrode 10. Examples of materials for the positive electrode charge-collecting foil 11 include aluminum, aluminum alloys, stainless steel, nickel, iron, and titanium, among which aluminum, aluminum alloys, and stainless steel are preferred. Examples of the shape of the positive electrode charge-collecting foil 11 include foil shapes and plate shapes.

The positive electrode layer 12 contains at least one positive electrode active material. The positive electrode active material may be any material, for example, any of those used in the positive electrode layer of common solid-state secondary batteries. Examples include layered active materials containing lithium, spinel-type active materials, and olivine-type active materials. Examples of positive electrode active materials include lithium cobalt oxide (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), heteroatom-doped Li—Mn spinel expressed by Li₁₊ₓMn_{2-x-y}MO₄ (x+y=2, M=at least one selected from Al, Mg, Co, Fe, Ni, and Zn), lithium titanate (oxides containing Li and Ti), and lithium metal phosphate (LiMPO4, M=at least one selected from Fe, Mn, Co, and Ni).

The positive electrode layer 12 may optionally contain a solid-state electrolyte to improve lithium-ion conductivity. It may also optionally contain a conductivity aid to improve conductivity. It may also optionally contain a binder to exhibit flexibility or the like. The solid-state electrolyte, the conductivity aid, and the binder may be, but are not limited to, those used in the positive electrode layer of common all-solid-state lithium batteries.

The material of the positive electrode tab 15 may be the same as the material of the positive electrode charge-collecting foil 11 or different from the material of the positive electrode charge-collecting foil 11. The positive electrode tab 15 may be coupled integrally with the positive electrode charge-collecting foil 11.

The negative electrode charge-collecting foil 21 may be composed of any material and have any shape, as long as they provide the function of collecting charge for the negative electrode 20. Examples of materials for the negative electrode charge-collecting foil 21 include nickel, copper, and stainless steel. Examples of the shape of the negative electrode charge-collecting foil 21 include foil shapes and plate shapes.

The negative electrode layer 22 may be composed of any material and have any shape, as long as they provide the function of depositing lithium ions in a dense manner. A metallic lithium layer or a layer of metal that forms an alloy with lithium can be used as the negative electrode layer 22. Examples of metals that form alloys with lithium include Mg, Si, Au, Ag, In, Ge, Sn, Pb, Al, and Zn. The metal forming the negative electrode layer 22 may be in the form of either powder or thin film. With the negative electrode 20 including this negative electrode layer 22, a uniform lithium deposition layer can be generated on the surface of the negative electrode layer 22.

The material of the negative electrode tab 25 may be the same as the material of the negative electrode charge-collecting foil 21 or different from the material of the negative electrode charge-collecting foil 21.

The solid-state electrolyte layer 30 has three separate layers, the separate layers being: a positive electrode-side solid-state electrolyte layer 31, a central solid-state electrolyte layer 32, and a negative electrode-side solid-state electrolyte layer 33. The positive electrode-side solid-state electrolyte layer 31, the central solid-state electrolyte layer 32, and the negative electrode-side solid-state electrolyte layer 33 each contain a solid-state electrolyte. The positive electrode-side solid-state electrolyte layer 31, the central solid-state electrolyte layer 32, and the negative electrode-side solid-state electrolyte layer 33 may contain either the same or different solid-state electrolytes.

The solid-state electrolyte may be any material that has lithium-ion conductivity, for example, a sulfide solid-state electrolyte, an oxide solid-state electrolyte, a nitride solid-state electrolyte, or a halide solid-state electrolyte. Examples of sulfide solid-state electrolytes include Li₂S—P₂S₅ and Li₂S—P₂S₅—LiI. The sulfide solid-state electrolyte may have an argyrodite crystal structure. Examples of oxide solid-state electrolytes include NASICON-type oxides, garnet-type oxides, and perovskite-type oxides. Examples of NASICON-type oxides include oxides containing Li, Al, Ti, P, and O (e.g., Li_{1.5}Al_{0.5}Ti_{1.5}(PO₄)₃). Examples of garnet-type oxides include oxides containing Li, La, Zr, and O (e.g. Li₇La₃Zr₂O₁₂). Examples of perovskite-type oxides include oxides containing Li, La, Ti, and O (e.g. LiLaTiO₃).

The solid-state electrolyte layer 30 may contain a binder. The binder may be any binder, for example, any of those used in the solid-state electrolyte layer of common solid-state secondary batteries.

The positive electrode-side solid-state electrolyte layer 31 may have, for example, a higher binder content than the central solid-state electrolyte layer 32 to improve adhesion with the positive electrode layer 12. The negative electrode-side solid-state electrolyte layer 33 may have, for example, a higher binder content than the central solid-state electrolyte layer 32 to improve adhesion with the negative electrode layer 22.

The intermediate layer 40 may, for example, improve the uniformity of lithium ions deposited on the negative electrode layer 22 of the negative electrode 20. The intermediate layer 40 may be an electron-conductive layer with voids through which lithium ions can pass. The intermediate layer 40 may contain a lithium metal-conductive material and an electron-conductive material. Amorphous carbon particles, for example, can be used as the lithium metal-conductive material. Examples of amorphous carbon particles include carbon blacks, such as acetylene black, furnace black, and Ketjen black, coke, activated carbon, carbon nanotubes (CNT), fullerenes, and graphene. A metal, for example, can be used as the electron-conductive material. The metal may be particles. Examples of the metal include Ag, Au, Pt, Pd, Si, Al, Bi, Sn, Zn, Ga, and In.

The insulating tape 50 includes an insulating resin layer and an adhesive layer. The insulating resin layer may be composed of any material as long as the layer is flexible. For example, a vinyl tape, a cellophane tape, or a polyimide tape can be used as the insulating tape 50.

According to the all-solid-state battery 100 of this embodiment configured as described above, the flexible insulating tape 50 is attached to the negative electrode charge-collecting foil extension 21a, which makes a short-circuit less likely to occur between the negative electrode charge-collecting foil extension 21a and the positive electrode charge-collecting foil 11. The insulating tape 50 is flexible and can follow the deformation of the negative electrode charge-collecting foil extension 21a. Accordingly, the negative electrode charge-collecting foil extension 21a easily deforms with changes in the thickness of the negative electrode layer 22 due to charging and discharging, and the insulating tape 50 does not easily peel off even if the negative electrode charge-collecting foil extension 21a is deformed. The flexible insulating tape 50 is attached to the negative electrode charge-collecting foil extension 21a, being at a distance from the negative electrode layer 22, which prevents the insulating tape 50 from riding up on the negative electrode layer 22 when the insulating tape 50 is attached to the negative electrode charge-collecting foil extension 21a. Moreover, since the edge of the solid-state electrolyte layer 30 on the negative electrode charge-collecting foil extension 21a side faces the insulating tape 50, even if there is a gap between the insulating tape 50 and the negative electrode layer 22, a short-circuit between the negative electrode charge-collecting foil extension 21a and the positive electrode charge-collecting foil 11 is unlikely to occur even if the negative electrode charge-collecting foil extension 21a is deformed toward the positive electrode layer 12. Furthermore, the insulating frame 13 is disposed at the outer edge of the positive electrode layer 12, which makes a short-circuit less likely to occur between the positive electrode charge-collecting foil extension 11a and the negative electrode charge-collecting foil 21 even if the positive electrode charge-collecting foil extension 11a is deformed.

Although the embodiment of the present invention has been described above, the present invention is not limited to the aforementioned embodiment. For example, although the solid-state electrolyte layer 30 has three layers in this embodiment, the solid-state electrolyte layer 30 may have a single layer. Further, although the insulating tape 50 and the solid-state electrolyte layer 30 (central insulating base) face each other with a gap therebetween in this embodiment, the insulating tape 50 and the solid-state electrolyte layer 30 may be in contact. Furthermore, although the thickness of the insulating tape 50 is made smaller than the distance between the negative electrode charge-collecting foil extension 21a and the solid-state electrolyte layer 30 in this embodiment, the thickness of the insulating tape 50 may be made larger than this distance so that the insulating tape 50 is crushed by the solid-state electrolyte layer 30.

### EXPLANATION OF REFERENCE NUMERALS

10 Positive electrode
11 Positive electrode charge-collecting foil
11a Positive electrode charge-collecting foil extension
12 Positive electrode layer
13 Insulating frame
15 Positive electrode tab
20 Negative electrode
21 Negative electrode charge-collecting foil
21a Negative electrode charge-collecting foil extension
22 Negative electrode layer
25 Negative electrode tab
30 Solid-state electrolyte layer
31 Positive electrode-side solid-state electrolyte layer
32 Central solid-state electrolyte layer
33 Negative electrode-side solid-state electrolyte layer
40 Intermediate layer
50 Insulating tape
100 All-solid-state battery

What is claimed is:

1. An all-solid-state battery comprising:
an electrode laminate comprising, in the following order, a positive electrode charge-collecting foil, a positive electrode layer, a solid-state electrolyte layer, a negative electrode layer, and a negative electrode charge-collecting foil, wherein
an edge of the positive electrode layer is located inward of edges of the solid-state electrolyte layer and the negative electrode layer,
the positive electrode charge-collecting foil has a positive electrode charge-collecting foil extension that is coupled to a positive electrode tab,
the negative electrode charge-collecting foil has a negative electrode charge-collecting foil extension that is coupled to a negative electrode tab,
an insulating frame is disposed at an outer edge of the positive electrode layer,
a flexible insulating tape is attached to a surface of the negative electrode charge-collecting foil extension on the positive electrode layer side, being at a distance from the negative electrode layer, and
an edge of the solid-state electrolyte layer on the negative electrode charge-collecting foil extension side faces the insulating tape.

2. The all-solid-state battery according to claim 1, wherein
the solid-state electrolyte layer has a plurality of layers being two or more layers, and at least one of the plurality of layers of the solid-state electrolyte layer has an edge on the negative electrode charge-collecting foil extension side that is approximately flush with an edge of the insulating frame.

3. The all-solid-state battery according to claim 1, wherein
the insulating tape has an extension that extends out from a position of an outer edge of the insulating frame, and a length of the extension is greater than or equal to a total thickness of the solid-state electrolyte layer, the positive electrode layer, and the positive electrode charge-collecting foil.

4. The all-solid-state battery according to claim 1, wherein
a thickness of the insulating tape is less than a distance between the negative electrode charge-collecting foil extension and the solid-state electrolyte layer.

5. The all-solid-state battery according to claim 1, wherein
the edge of the solid-state electrolyte layer on the negative electrode charge-collecting foil extension side is located near an edge of the insulating frame.

6. The all-solid-state battery according to claim 2, wherein
the solid-state electrolyte layer has separate layers, the separate layers being: a positive electrode-side solid-state electrolyte layer located on the positive electrode layer side, a negative electrode-side solid-state electrolyte layer located on the negative electrode layer side, and a central solid-state electrolyte layer located between the positive electrode-side solid-state electrolyte layer and the negative electrode-side solid-state electrolyte layer,
an edge of the positive electrode-side solid-state electrolyte layer on the negative electrode charge-collecting foil extension side is approximately flush with the edge of the insulating frame,
an edge of the central solid-state electrolyte layer on the negative electrode charge-collecting foil extension side is located inward of the edge of the positive electrode-side solid-state electrolyte layer, and
an edge of the negative electrode-side solid-state electrolyte layer on the negative electrode charge-collecting foil extension side is located inward of the edge of the central solid-state electrolyte layer.

7. An all-solid-state battery comprising:
an electrode laminate comprising, in the following order, a positive electrode charge-collecting foil, a positive electrode layer, a solid-state electrolyte layer, a negative electrode layer, and a negative electrode charge-collecting foil, wherein
the positive electrode charge-collecting foil has a positive electrode charge-collecting foil extension that is coupled to a positive electrode tab,
the negative electrode charge-collecting foil has a negative electrode charge-collecting foil extension that is coupled to a negative electrode tab,
an insulating frame is disposed at an outer edge of the positive electrode layer,
a flexible insulating tape is attached to a surface of the negative electrode charge-collecting foil extension on the positive electrode layer side, being at a distance from the negative electrode layer,
an edge of the positive electrode layer on the negative electrode charge-collecting foil extension side is located inward of edges of the solid-state electrolyte layer and the negative electrode layer,
an edge of the solid-state electrolyte layer on the negative electrode charge-collecting foil extension side faces the insulating tape, and
a thickness of the insulating tape is less than a distance between the negative electrode charge-collecting foil extension and the solid-state electrolyte layer.
